(19) United States
(12) Patent Application Publication
(10) Pub. No.: US 2005/0078186 A1
(43) Pub. Date: Apr. 14, 2005

(54) Video recorder

(76) Inventors: Barrett Morris Kreiner, Norcross, GA (US); Joseph E. Page JR., Suwanee, GA (US)

Correspondence Address: Scott P. Zimmerman, P.O. Box 3822, Cary, NC, 27519, US

(21) Appl. No.: 10/674,995

(22) Filed: Sep. 30, 2003

(51) Int. Cl. H04N 5/91; H04N 7/18; H04N 5/95; H04N 5/781

(52) U.S. Cl. 348/152; 386/89; 386/46; 348/154; 386/125

(57) ABSTRACT

Methods are disclosed for recording an event. Audio and/or video data of the event is stored in memory. The audio and/or the video data is also stored in a loop buffer. The contents of the loop buffer are transferred to the memory to provide time-delayed audio data and/or time-delayed video data. The time-delayed audio/video data precedes the event in time. The time-delayed audio/video data may be useful for reconstructing/analyzing the event.

### CROSS-REFERENCE TO RELATED APPLICATIONS

This patent application relates to the co-pending and commonly-assigned U.S. application Ser. No. ______ (docket BS030144), filed Sep. 30, 2003, and entitled “Video Recorder,” of which the “Brief Summary Of The Invention” section and the “Detailed Description of the Invention” section are incorporated herein by reference.

This patent application also relates to the co-pending and commonly-assigned U.S. application Ser. No. ______ (docket BS030265), filed Sep. 30, 2003, and entitled “Video Recorder,” of which the “Brief Summary Of The Invention” section and the “Detailed Description of the Invention” section are incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to image analysis and, more particularly, to image compression using adaptive coding.

2. Description of the Related Art

Prior art video security systems are not always effective. Whether the prior art video security system utilizes older, analog video cassette tapes, or more recent digital technologies, often times these prior art security systems do not capture important images that help resolve security situations. The older, analog video cassette-based systems, for example, produce hours of usually unimportant video. If a security situation arises, time and resources are squandered while the video tapes are manually reviewed for important information (e.g., the identity of a thief). Even the newer, digital surveillance technologies, using computer intelligence to isolate “important events,” often fail to capture information that can resolve security situations. By the time the computer intelligence has determined that something “important” is occurring, revealing information (such as the thief's face) has not been saved. There is, accordingly, a need in the art to capture video/audio data for improved surveillance needs, a need for producing surveillance data that does not require a large amount of time for manual review, and a need for improved recording of video and/or audio data that is compatible with digital technologies.

### BRIEF SUMMARY OF THE INVENTION

The aforementioned problems, and other problems, are reduced by a video recorder. This invention provides methods, apparatuses, computer programs, and computer program products for digitally recording video and/or audio data of an event. This invention provides digital storage of visual and aural data for improved quality and for simplified manipulation. Because this invention provides digital storage, the video and/or audio data may be formatted and presented on many different hardware and software systems (e.g., computers, personal digital assistants, cell phones, tablets, and other communications devices). The digital nature of the data may also be communicated in real-time, or near real-time, to monitoring agencies, law enforcement agencies/authorities, and other entities. This invention thus provides a simple, convenient, and effective means of storing and of communicating video and audio data.

The video recorder of this invention can record “backwards in time.” That is, this invention provides time-delayed video and audio data. The video recorder stores video and audio data in a loop buffer. The loop buffer stores video and audio data for a predetermined duration or elapse of time. Because the loop buffer stores anywhere from a few seconds to several minutes of video data, the loop buffer, at any one time, provides data from a time recently preceding the recorded event. The loop buffer thus provides both real-time and time-delayed video and audio data of the event captured by the camera. As this patent will further explain, this “time-delayed” video and audio data may be very useful for security and surveillance uses.

Methods are disclosed for recording an event. One method stores audio and/or video data of the event in memory. The audio and/or the video data is also stored in a loop buffer. The contents of the loop buffer are transferred to the memory to provide time-delayed audio data and/or time-delayed video data. The time-delayed audio/video data precedes the event in time. The time-delayed audio/video data may be useful when reconstructing/analyzing the event.

Another method is disclosed for recording an event. Audio/video data of the event is stored in memory, and the video data includes a series of picture frames. The audio/video data of the event is also stored in a loop buffer. Here the method specifies multiple regions of interest within a single picture frame and/or multiple regions of disinterest within the single picture frame. The contents of the loop buffer are transferred to the memory to provide time-delayed audio/video data. This time-delayed audio/video data precedes the event in time.

Still another method is disclosed for recording an event. Audio/video data of the event is stored in memory, and the video data includes a series of picture frames. The audio/video data of the event is also stored in a loop buffer. Multiple regions of interest within a single picture frame, and/or multiple regions of disinterest within the single picture frame, are specified. The contents of the loop buffer are transferred to the memory at a bitrate associated with a region of interest. The contents of the loop buffer provide time-delayed audio/video data. This time-delayed audio/video data precedes the event in time.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIG. 1 is a schematic illustrating a video recorder according to embodiments of this invention;

FIG. 2 is a more detailed schematic of the video recorder shown in FIG. 1;

FIG. 3 is a schematic of a vehicle incorporating the video recorder shown in FIGS. 1 and 2;

FIG. 4 is a flowchart illustrating a method for recording video data of an event; and

FIG. 5 is a flowchart illustrating yet another method for recording an event.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. Those of ordinary skill in the art further understand that the exemplary hardware, software, processes, methods, and/or operating systems described herein are for illustrative purposes and, thus, are not intended to be limited to any particular named manufacturer.

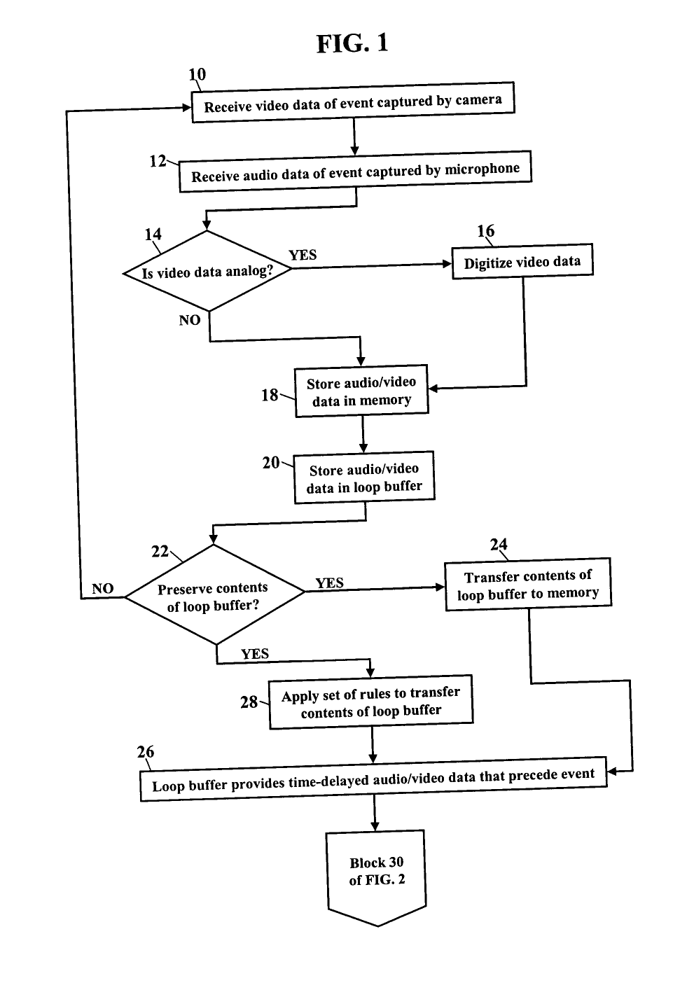

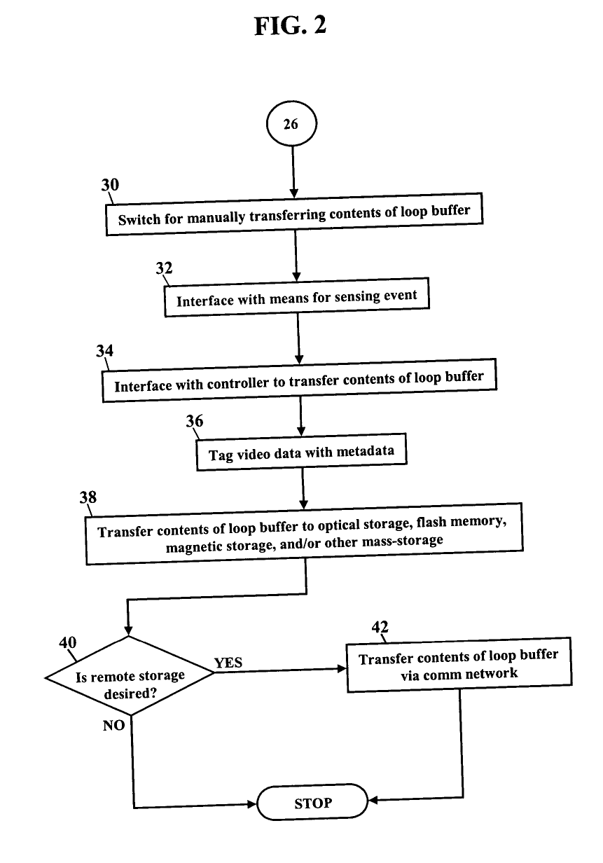

FIGS. 1 and 2 are flowcharts illustrating one of the embodiments of this invention. This invention provides methods, apparatuses, computer programs, and computer program products for recording video and/or audio data of an event. This invention provides digital storage of visual and aural data for improved quality and for simplified manipulation. Because this invention provides digital storage, the video and/or audio data may be formatted and presented on many different hardware and software systems (e.g., computers, personal digital assistants, cell phones, tablets, and other communications devices). The digital nature of the data may also be communicated in near real time to monitoring agencies, law enforcement agencies/authorities, and other entities. This invention thus provides a simple, convenient, and effective means of storing and of communicating video and audio data.

Those of ordinary skill in the art of computer programming will recognize computer processes/programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art.

The video recorder of this invention provides time-delayed video and audio data. The video recorder stores video and audio data in a loop buffer. The loop buffer stores video and audio data for a predetermined duration or elapse of time. Because the loop buffer stores anywhere from a few seconds to several minutes of video data, the loop buffer, at any one time, provides data from a time recently preceding the recorded event. The loop buffer thus provides both real-time and time-delayed video and audio data of the event captured by the camera. As this patent will further explain, this “time-delayed” video and audio data may be very useful for security and surveillance uses.

FIG. 1 illustrates a method for recording an event. Video data of an event, captured by a camera, is received at a video recorder (Block 10). The video data includes a series of picture frames that, when sequentially reviewed, resemble a motion picture of the event. The video recorder may also receive audio data of the event captured by a microphone (Block 12). If the video is in an analog form (Block 14), the video is digitized (Block 16). The audio data and the video data are stored in memory (Block 18) and stored in a loop buffer (Block 20). When the contents of the loop buffer are to be preserved (Block 22), the contents of the loop buffer are transferred to the memory (Block 24). The loop buffer provides time-delayed audio data and time-delayed video data that precede the event (Block 26). If the contents of the loop buffer are not to be preserved (Block 22), the video recorder continues receiving audio/video data (Blocks 10 and 12). A set of rules may be applied to transfer the contents of the loop buffer to the memory (Block 28).

The flowchart continues with FIG. 2. The video recorder may interface with a switch to manually transfer the contents of the loop buffer to the memory (Block 30). The video recorder may interface with means for sensing the event (Block 32). The video recorder may also interface with a controller to transfer the contents of the loop buffer to the memory (Block 34). The video recorder may tag the audio data and/or the video data with metadata (Block 36). The metadata provides a description of the contents of the loop buffer. The contents of the loop buffer may be transferred to an optical storage device, a flash memory storage device, a magnetic storage device, and/or another mass-storage device (Block 38). If remote storage is desired or required (Block 40), the contents of the loop buffer are transferred via a communications network (Block 42).

The loop buffer provides time-delayed audio/video data. As those of ordinary skill in the art understand, the loop buffer stores the audio data and the video data for a predetermined duration or elapse of time (typically from a few seconds to several minutes). This audio/video data is stored in a plurality of data registers. These data registers are coupled in series, such that an output of the first register is coupled to an input of the next register in the series. The audio/video data thus shuttles from one register to the next register, thus providing time to execute logical instructions concerning the data. When the audio/video data reaches the last register in the series, the audio/video data must either be saved/transferred to a more permanent memory device, or the audio/video data must be discarded. Because the loop buffer stores anywhere from a few seconds to several minutes of audio/video data, the loop buffer provides audio data and video data from a time recently preceding the recorded event. As this patent will further explain, this “time-delayed” audio/video data may be very useful for security and surveillance uses. Because, however, the operational and architectural concepts of loop buffers are known, this patent will not further describe the loop buffer. If the reader desires a more detailed explanation of loop buffers, the reader is invited to consult U.S. Pat. No. 6,598,155 to Ganapathy et al. (Jul. 22, 2003), of which the “Detailed Description of the Preferred Embodiment” section is incorporated herein by reference.

The video recorder may include a set of rules. This set of rules is stored in memory. The set of rules can determine when to transfer the contents of the loop buffer to a more permanent memory device (such as an optical/magnetic storage device, RAM/EEPROM memory, a flash memory storage device, a magnetic storage device, and/or another mass-storage device). The set of rules are logical rules, and each rule describes an event, occurrence, or detection that causes the contents of the loop buffer to be transferred to the more permanent memory device. When the set of rules determines to transfer the contents of the loop buffer to memory, the memory then stores time-delayed audio and video data. This time-delayed audio and video data precedes the event, occurrence, or detection that triggered the transfer. The contents of the loop buffer thus contain audio data and video data that precede the event, occurrence, or detection. If the audio data and the video data are synchronized, the audio data and the video data may be very useful for security and surveillance.

The video recorder may interface with other means for sensing the event to be recorded. The video recorder, for example, could interface with a Heating, Ventilation, and Air Conditioning (HVAC) system. The set of rules could define HVAC conditions that activate the video recorder and/or that transfer the contents of the loop buffer into the memory. The video recorder could also interface with a switch, a transducer, or a pressure pad. The set of rules could specify what opened and/or closed positions of the switch that activate the video recorder and/or that transfer the contents of the loop buffer. The set of rules could also specify voltage/current conditions of the transducer and/or of the pressure pad that activate the video recorder and/or that transfer the contents of the loop buffer. The video recorder could also interface with a voltage/current sensor and an electromagnetic sensor. The set of rules could specify voltage/current conditions measured by the voltage/current sensor that activate the video recorder and/or that transfer the contents of the loop buffer. The set of rules, similarly, could specify frequencies (e.g., infrared, RF, or radioactive) detected by the electromagnetic sensor that activate the video recorder and/or that transfer the contents of the loop buffer. The video recorder could also interface with a controller/computer that instructs the video recorder to operate. The video recorder could also interface with a temperature sensor (such as high heat or fire), a water sensor, a smell/scent sensor (such as liquid propane or liquid natural gas), and/or a sensor for detecting sounds. The video recorder interfaces with these means for sensing the event and initiates the video data and/or the audio data of the event.

The video recorder may also interface with a communications network. This interface allows the video recorder to transfer the contents of the memory, and/or the loop buffer, to a remote location. The interface could include a physical connection (e.g., a wire, optical fiber, or cable connection) to the communications network. The interface, however, may also utilize a wireless protocol to a wireless communications network. Wireless networks, such as those utilizing the I.E.E.E. 802 family of wireless standards, could be used to transfer the contents of the loop buffer to one or more remote locations. The interface may also utilize any portion of the electromagnetic spectrum, and the interface may utilize any signaling standard or method. The video recorder, for example, could transfer the contents of the loop buffer to a peripheral storage device via the wireless interface to the communications network. When the video recorder comes within range of a wireless network (e.g., a “Wi-Fi” network), the set of rules could specify that the contents of the loop buffer be wirelessly transferred to a peripheral storage device. The set of rules could also specify the conditions at which the video data and/or the audio data are communicated via the communications network to a remote location or entity (e.g., a monitoring agency or a remote storage facility/device).

The video recorder may also utilize metadata. The term “metadata” describes any data, description, narration, or explanation of other data. Here the set of rules may add, append, supplement, or tag the video data and/or the audio data with the metadata. The metadata may be any information, such as a description of a rule that caused the contents of the loop buffer to be transferred to at least one of the memory devices. The metadata may also include audio/textual narration that further describes the video data and/or the audio data.

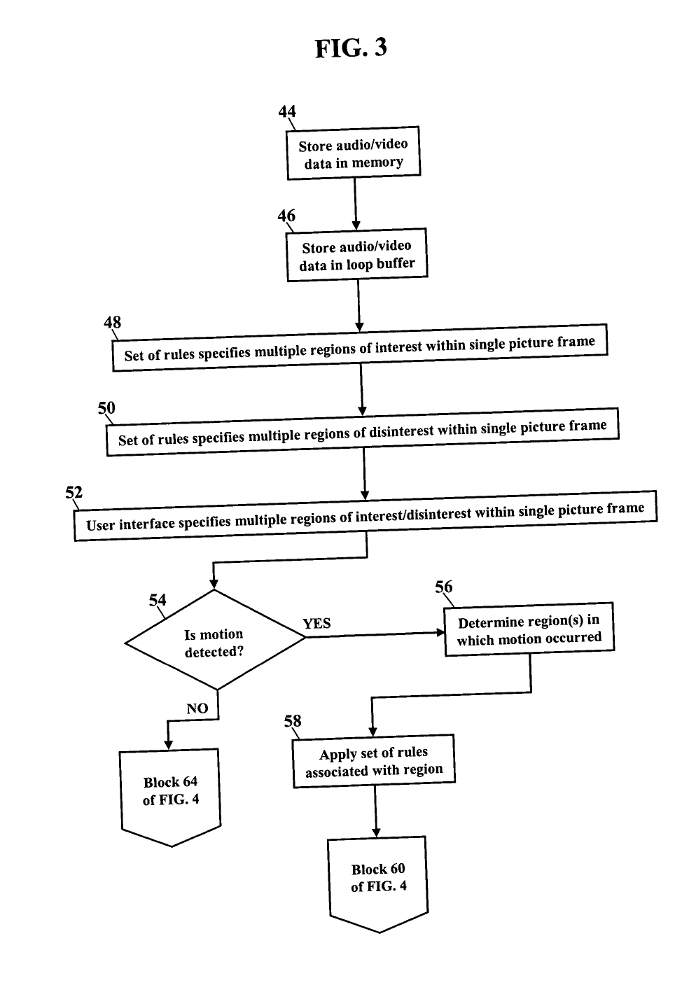

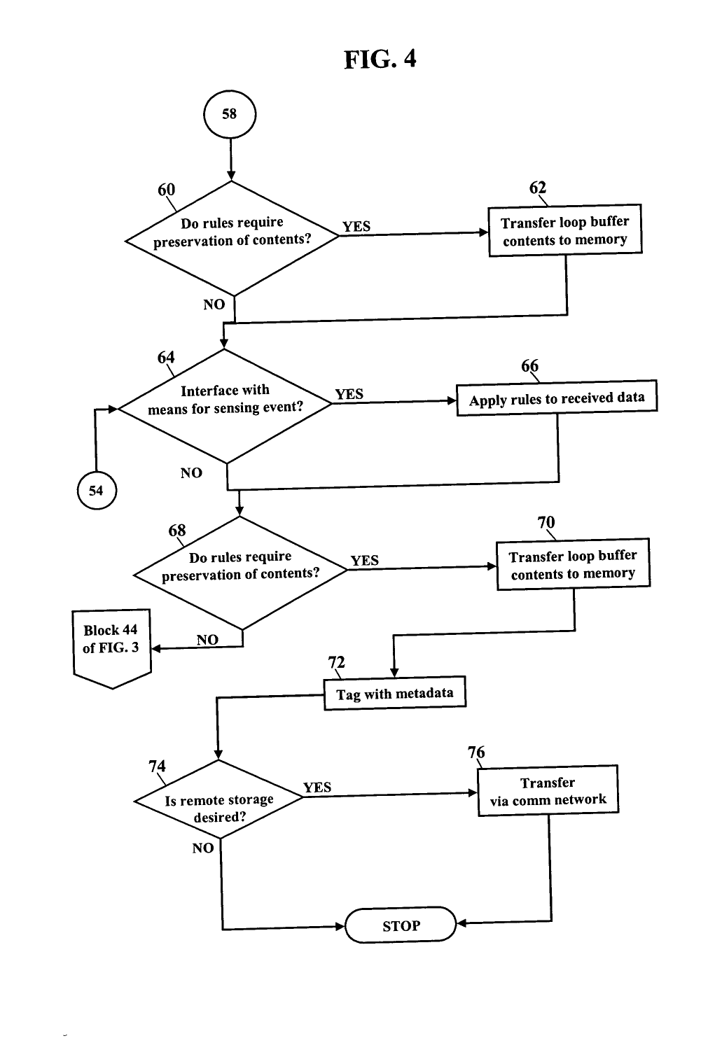

FIGS. 3 and 4 are flowcharts illustrating another method for recording an event. Video data and/or audio data of an event are stored in memory (Block 44) and stored in a loop buffer (Block 46). A set of rules specifies multiple regions of interest within a single picture frame (Block 48). The set of rules may also specify multiple regions of disinterest within the single picture frame (Block 50). A user may also utilize a user interface to specify regions of interest and regions of disinterest (Block 52). When motion is detected (Block 54), the video recorder determines in what region(s) that motion occurred (Block 56). Any method of detecting motion within the single frame is applicable to this invention, such as a means for detecting motion that measures pixel changes over time. The video recorder then applies the set of rules associated with that region (Block 58).

The flowchart continues with FIG. 4. If the set of rules requires preservation of the contents of the loop buffer (Block 60), the contents of the loop buffer are transferred to memory (Block 62). If the video recorder interfaces with means for sensing the event (Block 64), the video recorder applies the set of rules to any data received from the means for sensing the event (Block 66). If the set of rules requires preservation of the contents of the loop buffer (Block 68), the contents of the loop buffer are transferred to memory (Block 70). The audio data and/or the video data may be tagged with metadata describing the contents of the loop buffer and/or the audio/video data (Block 72). If the audio data and/or the video data is to be communicated to a remote location (Block 74), the audio/video data and/or the contents of the loop buffer are transferred via a communications network (Block 76).

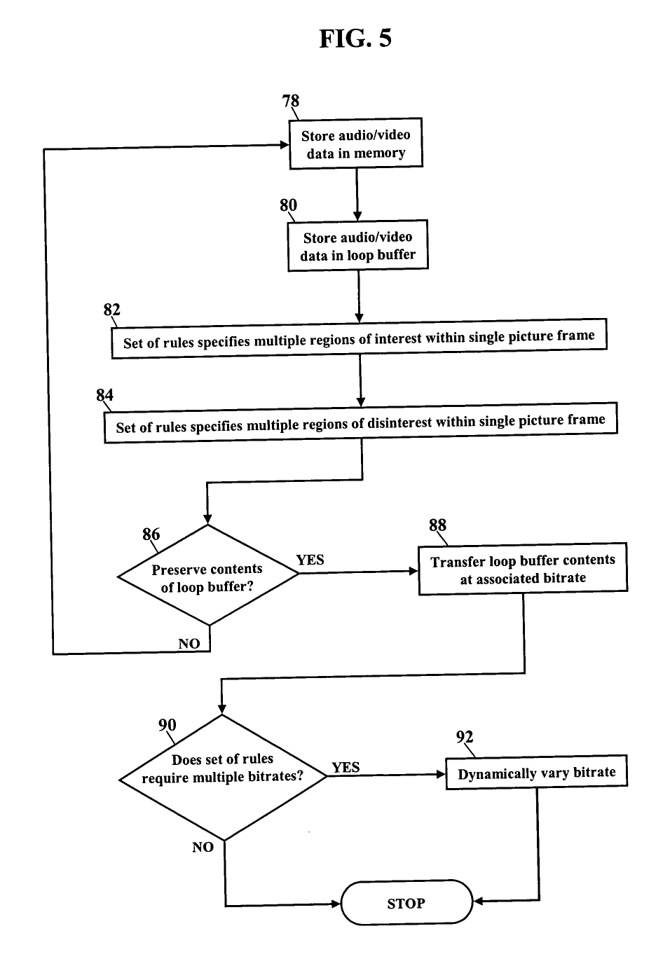

FIG. 5 is a flowchart illustrating yet another method for recording an event. Video data and/or audio data of an event are stored in memory (Block 78) and stored in a loop buffer (Block 80). A set of rules specifies multiple regions of interest within a single picture frame (Block 82). The set of rules may also specify multiple regions of disinterest within the single picture frame (Block 84). If the set of rules requires preservation of the contents of the loop buffer (Block 86), the contents of the loop buffer are transferred to memory at a bitrate associated with either a region of interest or a region of disinterest (Block 88). If the set of rules requires (Block 90), the bitrate may be dynamically varied (Block 92). The transfer bitrate may be dynamically varied, for example, when motion is detected in different regions, and each region has an associated, but different, bitrate. The transfer bitrate could also be dynamically varied when multiple “interesting” events are detected, such as when a door switch, a thermal/temperature sensor, and a pressure pad all indicate the presence of an intruder. Whenever the set of rules requires differing transfer bitrates, the video recorder of this invention can dynamically vary the bitrate to satisfy the set of rules.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method, comprising:
storing in memory at least one of audio data and video data of an event, the video data comprising a series of picture frames;
storing at least one of the audio data and the video data in a loop buffer; and
transferring the contents of the loop buffer to the memory to provide at least one of time-delayed audio data and time-delayed video data, the time-delayed audio data and the time-delayed video data preceding the event.

2. A method according to claim 1, further comprising applying a set of rules to transfer the contents of the loop buffer to memory.

3. A method according to claim 1, further comprising transferring the contents of the loop buffer to a mass-storage device.

4. A method according to claim 1, further comprising transferring the contents of the loop buffer to an optical storage device.

5. A method according to claim 1, further comprising transferring the contents of the loop buffer to a flash memory storage device.

6. A method according to claim 1, further comprising communicating the contents of the loop buffer via a communications network.

7. A method according to claim 1, further comprising interfacing with a switch to transfer the contents of the loop buffer to the memory.

8. A method according to claim 1, further comprising interfacing with a vehicle controller to transfer the contents of the loop buffer to the memory.

9. A method according to claim 1, further comprising tagging the video data with metadata, the metadata providing a description of the contents of the loop buffer.

10. A method according to claim 1, further comprising interfacing with means for sensing the event.

11. A method, comprising:
storing in memory at least one of audio data and video data of an event, the video data comprising a series of picture frames;
storing at least one of the audio data and the video data in a loop buffer;
specifying at least one of i) multiple regions of interest within a single picture frame and ii) multiple regions of disinterest within the single picture frame; and
transferring the contents of the loop buffer to the memory, the contents of the loop buffer providing at least one of time-delayed audio data and time-delayed video data, the time-delayed audio data and the time-delayed video data preceding the event.

12. A method according to claim 11, further comprising transferring the contents of the loop buffer to an optical storage device.

13. A method according to claim 11, further comprising applying a set of rules when specifying the multiple regions of interest and the multiple regions of disinterest.

14. A method according to claim 11, further comprising applying a set of rules to transfer the contents of the loop buffer to the memory.

15. A method according to claim 11, further comprising interfacing with means for sensing the event.

16. A method according to claim 11, further comprising communicating the contents of the loop buffer via a communications network.

17. A method according to claim 11, further comprising tagging the video data with metadata, the metadata providing a description of the contents of the loop buffer.

18. A method, comprising:
storing in memory at least one of audio data and video data of an event, the video data comprising a series of picture frames;
storing at least one of the audio data and the video data in a loop buffer;
specifying at least one of i) multiple regions of interest within a single picture frame and ii) multiple regions of disinterest within the single picture frame;
transferring the contents of the loop buffer to the memory, the contents of the loop buffer transferred at a bitrate associated with the region of interest, the contents of the loop buffer providing at least one of time-delayed audio data and time-delayed video data, the time-delayed audio data and the time-delayed video data preceding the event in time.

19. A method according to claim 18, further comprising applying a set of rules to transfer the contents of the loop buffer to the memory.

20. A method according to claim 18, further comprising applying a set of rules to dynamically vary the bitrate of the transferred contents of the loop buffer.
